(19) United States
(12) Patent Application Publication
(10) Pub. No.: US 2010/0310970 A1
(43) Pub. Date: Dec. 9, 2010

(54) DIRECT-METHANOL FUEL CELL

(76) Inventor: Tomoaki Arimura, Hamura-shi (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/792,481

(22) Filed: Jun. 2, 2010

(30) Foreign Application Priority Data
Jun. 9, 2009 (JP) 2009-138498

(51) Int. Cl. H01M 8/02

(52) U.S. Cl. 429/514

(57) ABSTRACT

According to one embodiment, a direct-methanol fuel cell includes an anode into which an aqueous methanol solution is introduced, a cathode to which oxidizing gas is introduced, an electrolyte membrane interposed between the anode and the cathode, an anode separator which is disposed on the anode side and formed a fuel passage on a surface opposite the anode, a cathode separator which is disposed on the cathode side and formed an oxidizing gas passage on a surface opposite the cathode, an anode frame seal member disposed in such a manner as to surround the fuel passage between the anode and the anode separator, and a cathode frame seal member disposed in such a manner as to surround the oxidizing gas passage between the cathode and the cathode separator. The each seal member is fixed to the each separator, and the each seal member comprises an ionic polymer.

### CROSS-REFERENCE TO RELATED APPLICATIONS

This application is based upon and claims the benefit of priority from Japanese Patent Application No. 2009-138498, filed Jun. 9, 2009; the entire contents of which are incorporated herein by reference.

### FIELD

Embodiments described herein relate generally to a direct-methanol fuel cell.

### BACKGROUND

A direct-methanol fuel cell comprises a unit cell having an anode, into which an aqueous methanol solution is introduced as a fuel, a cathode, into which oxidizing gas such as air is introduced, an electrolyte membrane interposed between these electrodes, anode and cathode separators which are disposed on the surface of each electrode and formed with a passage groove, and a seal member disposed between each electrode and each separator.

The seal member is obtained by punching a thin rubber sheet and has a frame form. The seal member is disposed in a space between the anode and the separator and a space between the cathode and the separator, and has a function to seal fuel and oxidizing gas, respectively.

A fine clearance is produced between the seal member and each electrode when a unit cell is driven. This is caused primarily by the deformation of each electrode and uneven fastening pressure along with, primarily, the expansion and shrinkage of the electrolyte membrane and impact on the unit cell. A conventional rubber seal member is stuck to the surface of each electrode by fastening each separator on each electrode with a bolt by utilizing the deformation of the seal member having elasticity. For this reason, it is difficult to fill up fine clearances between the seal member and each electrode only by the deformation of the seal member. As a result, fuel and oxidizing gas supplied to each separator when the unit cell is driven leak through the clearances, giving rise to a problem concerning reduced output.

### BRIEF DESCRIPTION OF THE DRAWING

FIG. 1 is a sectional view showing a direct-methanol fuel cell according to an embodiment;

FIG. 2 is a plan view showing the surface of an anode separator on the fuel passage side, the separator being incorporated into a fuel cell of FIG. 1;

FIG. 3 is a view showing a current-voltage curve of each evaluation cell obtained in Examples 1 to 6 and Comparative Example 2; and

FIG. 4 is a view showing a variation in the voltage of each evaluation cell obtained in Examples 1 to 6 and Comparative Example 2 when the cell is operated for a long period of time at a current density kept constant.

### DETAILED DESCRIPTION

In general, according to one embodiment, a direct-methanol fuel cell comprises an anode, into which an aqueous methanol solution is introduced as a fuel; a cathode, into which oxidizing gas is introduced; an electrolyte membrane interposed between the anode and the cathode; an anode separator which is disposed on the anode side and formed with a fuel passage on a surface opposite the anode; a cathode separator which is disposed on the cathode side and formed with an oxidizing gas passage on a surface opposite the cathode; an anode frame seal member disposed in such a manner as to surround the fuel passage between the anode and the anode separator; and a cathode frame seal member disposed in such a manner as to surround the oxidizing gas passage between the cathode and the cathode separator, wherein the each seal member is clamped the each separator, and the each seal member comprises an ionic polymer represented by the following formula (I).

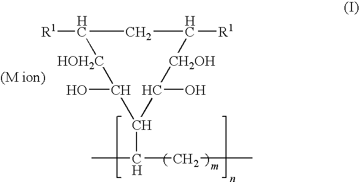

Where R¹ represents a COOH group or an H₂PO₄ group, the M ion represents Mg²⁺, Ca²⁺ or Al³⁺, m is an integer of 1 to 30 and n is an integer of 10 to 80.

That is, the ionic polymer has a structure in which a metal ion and plural cyclooctane groups having a hydrophilic group are bound with a principal chain as shown in formula (I).

m in the formula (I) is preferably 1 to 20.

In one embodiment, each seal member consists essentially of the ionic polymer represented by the formula (I) or a mixture of the ionic polymer and filler.

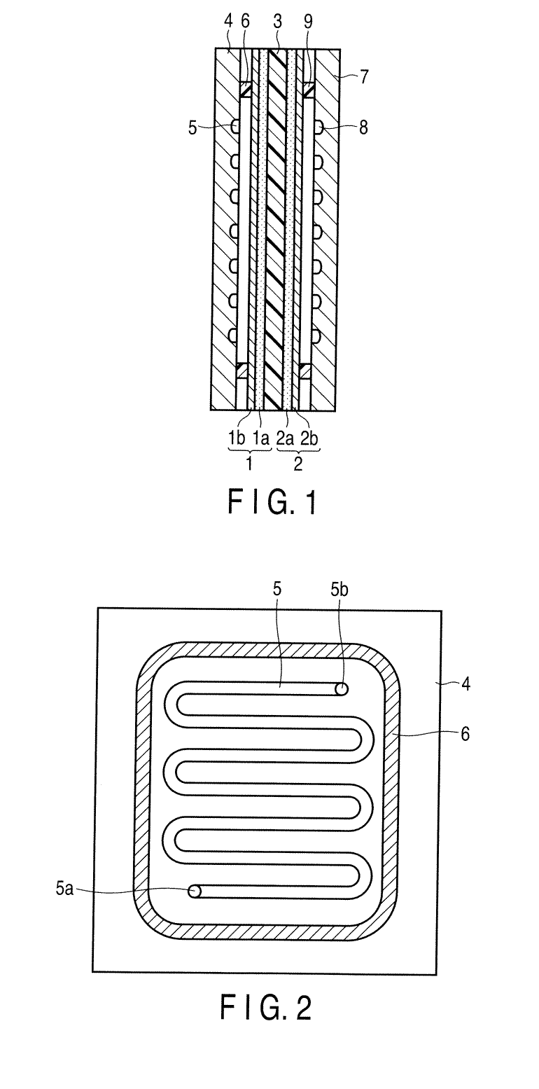

A specific structure of a direct-methanol fuel cell according to the embodiment will be explained with reference to FIGS. 1 and 2. FIG. 1 is a sectional view showing a unit cell of the fuel cell according to this embodiment and FIG. 2 is a plan view showing the surface of an anode separator on the fuel passage side, the separator being incorporated into the fuel cell of FIG. 1.

In the figures, an aqueous methanol solution is introduced into an anode 1, and oxidizing gas is introduced into a cathode 2. An electrolyte membrane 3 is interposed between these anode 1 and cathode 2. The anode 1 is constituted of a first catalyst layer 1a which is in contact with the electrolyte membrane 3 and a diffusion layer 1b, such as carbon paper, laminated on the first catalyst layer 1a. The cathode 2 is constituted of a second catalyst layer 2a which is in contact with the electrolyte membrane 3 and a diffusion layer 2b, such as carbon paper, laminated on the second catalyst layer 2a.

The anode separator 4 is disposed on the anode 1 side, and has a fuel passage, for example a meandering fuel passage 5 formed on the surface facing the anode 1. An anode frame seal member 6 containing an ionic polymer represented by the above formula (I) is disposed so as to surround the fuel passage 5 between the anode 1 and the separator 4. The fuel passage 5 comprises a fuel supply port 5a formed so as to penetrate through the separator 4, on one end as shown in FIG. 2 and a fuel discharge port 5b formed so as to penetrate through the separator 4 on the other end. The frame seal member 6 is integrated with the surface of the separator 4 on which the fuel passage 5 is formed, as shown in FIG. 2. In such a stacked structure of the anode 1, frame seal member 6 and separator 4, the frame seal member 6 is fixed to the separator 4 and the surface of the frame seal member 6 on the side opposite the separator 4 is mechanically brought into contact with the anode 1. The frame seal member 6 is fix to the surface of the separator 4 by applying a solution containing an ionic polymer represented by the formula (I), which will be explained later, by means of a nozzle to the surface of the separator 4 on which the fuel passage 5 is formed, followed by drying.

A cathode separator 7 is disposed on the cathode 2 side, and has an oxidizing gas passage, for example a meandering oxidizing gas passage 8 formed on the surface facing the cathode 2. A cathode frame seal member 9 containing an ionic polymer represented by the above formula (I) is disposed so as to surround an oxidizing gas passage 8 between the cathode 2 and the separator 7. The oxidizing gas passage 8 comprises an oxidizing gas supply port (not shown) formed so as to penetrate through the separator 7, on one end and an oxidizing gas discharge port (not shown) formed so as to penetrate through the separator 4 on the other end. The frame seal member 9 is fixed to the surface of the separator 7 on which the oxidizing gas passage 8 is formed. In such a stacked structure of the cathode 2, frame seal member 9 and separator 7, the frame seal member 9 is fixed to the separator 7 and the surface of the frame seal member 9 on the side opposite the separator 7 is mechanically brought into contact with the cathode 2. The frame seal member 9 is fixed to the surface of the separator 7 on which the oxidizing gas passage 8 is formed, by applying a solution containing an ionic polymer represented by the formula (I), by means of a nozzle to the surface of the separator 7, followed by drying.

These anode separator 4, anode 1, electrolyte membrane 3, cathode 2 and cathode separator 7 are clamped each other by means of a bolt and a nut (not shown).

The direct-methanol fuel cell according to the embodiment explained above has a structure in which the anode frame seal member is disposed between the anode and the anode separator in such a manner as to surround the fuel passage, the cathode frame seal member is disposed between the cathode and the cathode separator in such a manner as to surround the oxidizing gas passage, each of the seal members is fixed to each separator, and each seal member comprises an ionic polymer represented by the above formula (I).

In a fuel cell having such a structure, the expansion and shrinkage of the electrolyte film disposed between the anode and the cathode are repeated, when methanol as the fuel is introduced into the anode separator and oxidizing gas such as air is introduced into the cathode separator to generate electricity. For this reason, fine clearances are produced between the anode and the frame seal member which is mechanically in contact with the anode and between the cathode and the frame seal member which is mechanically in contact with the cathode. Also, in the case where an impact such as vibration is given to the fuel cell, fine clearances are similarly produced.

The seal member used in the fuel cell of the embodiment contains an ionic polymer having a structure in which a metal ion and plural cyclooctane groups having a hydrophilic group are bonded with its principal chain as shown in the formula (I), wherein the cyclooctane group is hydrophilic to an aqueous methanol solution. Therefore, these cyclooctane groups take in a part of the aqueous methanol solution introduced and, at the same time, aggregate with each other to embrace the aqueous methanol solution therein. As a result, the seal member containing the ionic polymer develops such a self-repairing function that it is increased in volume to autonomously fill up fine clearances produced between the cathode and the seal member. The cathode frame seal member containing an ionic polymer represented by the formula (I), on the other hand, embraces an aqueous methanol solution introduced by crossover and is therefore increased in volume within a micro-range. Consequently, it develops such a self-repairing function that it autonomously fills up fin clearances produced between the cathode and the seal member.

Because the seal member itself can autonomously fill up fine clearances produced between the anode and the seal member and between the cathode and the seal member, the aqueous methanol solution introduced into the anode separator and the oxidizing gas introduced into the cathode separator can be prevented from leaking through the above fine clearances. This makes it possible to provide a direct-methanol fuel cell improved in output characteristics and safety.

Examples of the present invention will be explained in detail.

### Synthetic Example 1

A 100 mL round-bottomed reactor equipped with a Dimroth condenser, oil bath and magnetic stirrer was charged with 20 parts of a polyethylene pellet (number average molecular weight: 4000) manufactured by Aldrich Corporation and 50 mL of N,N-dimethylformamide. Sixteen parts of thionyl chloride was slowly added to the mixture by a syringe. The oil bath was heated to 50° C. to stir the mixture in the reactor for 2 hours. In succession, the mixture in the reactor was poured into 100 parts of crushed ice in a beaker. Ten centrifuge tubes were each charged with 10 parts of the cooled mixture and then centrifuged at 3000 rpm for 10 minutes by means of a table-top centrifuge (trade name: 4000-model, manufactured by Kubota Corporation) to precipitate resin components. After the supernatant was treated as a waste, each centrifuge tube was charged with an aqueous 5% ammonia solution and the mixture in each centrifuge tube was stirred by a spatula. Then, each centrifuge tube was again centrifuged at 3000 rpm to obtain polyethylene chloride.

The number (the number of n in the above formula) of repetitions of the hydrocarbon group was found by an elemental analyzer. Each contents of carbon and hydrogen in the polyethylene chloride was found by a 2400 II CHNS/O model manufactured by Perkin Elmer Japan Co., Ltd. Also, the content of chlorine in the polyethylene chloride was found by means of an organic halogen/sulfur microanalysis system (trade name: HSU-15, manufactured by Yanako. The average introduction rate of chlorine and the number (the number of m in the above formula (I)) of methylene groups at the principal chain were found from the contents of carbon, hydrogen and chlorine.

Also, a two-necked, round-bottomed flask equipped with a septum, calcium chloride drying tube and magnetic stirrer was prepared as a reactor. The reactor was charged with 3 parts of cyclooctane 1-chloro-2,8-diol-3,7-dimethanol-4,6-dicarboxylate, to which was then added 50 parts of tetrahydrofuran while stirring means of the magnetic stirrer to dissolve. Three parts of lithium chloride was added to the solution while the reactor was cooled in an ice bath. After the solution was stirred for 30 minutes, 5 parts of copper iodide was added to the solution, followed by stirring for 2 hours to obtain a metal complex of lithium copper and a dimer of a cyclooctane functional group.

Then, a two-necked, round-bottomed flask equipped with a septum, calcium chloride drying tube and magnetic stirrer was prepared as a reactor. The reactor was charged with 10 parts of the chlorinated polymer obtained previously, to which was then added 50 parts of tetrahydrofuran and the mixture was stirred for 30 minutes. Fifteen parts of the metal complex previously obtained was further added in the reactor and the resulting mixture was stirred at 25° C. for 30 minutes. Ten parts of an aqueous 5% ammonia solution was added to the resulting reaction solution to neutralize, thereby precipitating a polymer component.

Ten centrifuge tubes were each charged with 10 parts of a dispersion solution of the obtained polymer component and then centrifuged at 3000 rpm for 10 minutes by means of a table-top centrifuge (trade name: 4000-model, manufactured by Kubota Corporation) to precipitate a polymer. After the obtained polymer was dissolved in 30 parts of water, 5 parts of magnesium chloride was added to obtain a polymer solution. The polymer in the solution had a structure represented by the above formula (I) in which a COOH group was introduced as R¹, m was 2, n was 10 and Mg²⁺ was introduced as the M ion.

### Synthetic Example 2

A polymer solution was obtained in the same manner as in Synthetic Example 1 except that the amount of thionyl chloride was changed to 14 parts and calcium chloride was used in place of magnesium chloride. The polymer in the solution had a structure represented by the above formula (I) in which a COOH group was introduced as R¹, m was 4, n was 30 and Ca²⁺ was introduced as the M ion.

### Synthetic Example 3

A polymer solution was obtained in the same manner as in Synthetic Example 1 except that the amount of thionyl chloride was changed to 12 parts and aluminum chloride was used in place of magnesium chloride. The polymer in the solution had a structure represented by the above formula (I) in which a COOH group was introduced as R¹, m was 6, n was 40 and Al³⁺ was introduced as the M ion.

### Synthetic Example 4

A polymer solution was obtained in the same manner as in Synthetic Example 1 except that cyclooctane 1-chloro-2,8-diol-3,7-dimethanol-4,6-phosphate was used in the same amount in place of cyclooctane 1-chloro-2,8-diol-3,7-dimethanol-4,6-dicarboxylate and the amount of thionyl chloride was changed to 10 parts. The polymer in the solution had a structure represented by the above formula (I) in which an H PO₄ group was introduced as 0, m was 12, n was 50 and Mg²⁺ was introduced as the M ion.

### Synthetic Example 5

A polymer solution was obtained in the same manner as in Synthetic Example 1 except that cyclooctane 1-chloro-2,8-diol-3,7-dimethanol-4,6-phosphate was used in the same amount in place of cyclooctane 1-chloro-2,8-diol-3,7-dimethanol-4,6-dicarboxylate, the amount of thionyl chloride was changed to 5 parts and calcium chloride was used in place of magnesium chloride. The polymer in the solution had a structure represented by the above formula (I) in which an H₂PO₄ group was introduced as R¹, m was 20, n was 70 and Ca²⁺ was introduced as the M ion.

### Synthetic Example 6

A polymer solution was obtained in the same manner as in Synthetic Example 1 except that cyclooctane 1-chloro-2,8-diol-3,7-dimethanol-4,6-phosphate was used in the same amount in place of cyclooctane 1-chloro-2,8-diol-3,7-dimethanol-4,6-dicarboxylate, the amount of thionyl chloride was changed to 2 parts and aluminum chloride was used in place of magnesium chloride. The polymer in the solution had a structure represented by the above formula (I) in which an H₂PO₄ group was introduced as R¹, m was 30, n was 80 and Al³⁺ was introduced as the M ion.

(Permeability Test of an Aqueous Methanol Solution)

Each of the polymer solutions obtained in Synthetic Examples 1 to 6 was added dropwise to a spin coater (trade name: MS-A100, manufactured by Mikasa Co., Ltd.) which was rotated at 100 rpm, to form a cast film. Each cast film was air-dried for 2 hours and then, peeled from the spin coater. The peeled cast film (thickness: 0.2 mm) was cut into a circular form 70 mm in diameter and then, three holes 200 μm in diameter were formed by drilling in the center to manufacture an evaluation film.

Two stainless separable flasks each provided with a flange and having a diameter of 50 mm and an inside depth of 70 mm were prepared. A pump was connected with a hole formed in the side surface of one of these separable flasks through a pipe. This structural body was defined as vessel A. A rubber stopper was set in a hole formed in the side surface of the other separable flask and a syringe was set in this rubber stopper. This structural body was defined as vessel B. Vessel B collects generated gaseous methanol. Vessel A was disposed in such a manner that the opening part faces upward and the vessel was filled with an aqueous 20% methanol solution. After that, the above evaluation film was overlapped on the opening part of vessel A and the opening part of vessel B was placed on the evaluation film. Vessels A and B and the evaluation film interposed between the openings of vessels A and B were secured by stoppers to prepare an evaluation tester. Specifically, the evaluation film was sandwiched between the openings of vessels A and B to secure it. Such an evaluation tester was horizontally placed such that the pipe-fitting part of vessel A and the stopper-setting part of vessel B faced upward.

The pressure in vessel A of the evaluation tester was increased to 0.11 MPa by a pump. After ten minutes, the gas in vessel B was collected by a syringe. Methanol in the collected gas was converted into a derivative by means of a trimethylsilyl-forming (TMS) agent and the derivative was introduced into a gas chromatograph (trade name: GC2010, manufactured by Shimadzu Corporation) to measure the amount of gaseous methanol by means of GC-Solution Ver. 2.0 analysis software while using the peak area of a standard material having a known concentration.

As Comparative Example 1, the same evaluation film as above was produced from a butyl rubber sheet 0.2 mm in thickness and subjected to the same permeability test using an aqueous methanol solution.

The amount of methanol permeating each evaluation film obtained in Synthetic Examples 1 to 6 was calculated as a relative value when the amount of methanol permeating the evaluation film of Comparative Example 1 was set to 100. The results are shown in Table 1 below.

(Permeability Test of Gaseous Oxygen)

Each of the polymer solutions obtained in Synthetic Examples 1 to 6 was added dropwise to a spin coater (trade name: MS-A100, manufactured by Mikasa Co., Ltd.) which was rotated at 100 rpm, to form a cast film. Each cast film was air-dried for 2 hours and then, peeled from the spin coater. The peeled cast film (thickness: 0.2 mm) was cut into a circular form 70 mm in diameter to manufacture an evaluation film.

Two stainless separable flasks having a diameter of 50 mm and an inside depth of 70 mm were prepared. An oxygen cylinder was connected with a hole formed in the side surface of one of these separable flasks through a pipe. In this case, a female thread was formed on the outer peripheral surface of the opening part of the one separable flask by cutting. This structural body was defined as a first vessel. A stainless pipe was connected to a hole formed in the side surface of the other separable flask through a stainless connector and a gas chromatograph (trade name: GC2010, manufactured by Shimadzu Corporation) was connected to the end of the pipe. In this case, a jaw part with a male thread cut therein was formed on the opening of the other separable flask. This structural body was defined as a second vessel. The above evaluation film was disposed on the ends of the first and second vessels and the male thread of the jaw part of the second vessel was fitted with the female thread to secure the evaluation film between the opening parts of the first and second vessels, thereby preparing an evaluation tester.

The atmosphere in the second vessel was substituted with gaseous nitrogen in advance. Gaseous oxygen was supplied to the first vessel from an oxygen cylinder under a pressure of 0.11 MPa. After ten minutes, oxygen in the second vessel was introduced into a gas chromatograph (trade name: GC2010, manufactured by Shimadzu Corporation) to measure the amount of permeated gaseous oxygen by means of GC-Solution Ver. 2.0 analysis software while using the peak area of a standard material having a known concentration.

As Comparative Example 1, the same evaluation film as above was produced from a butyl rubber sheet 0.2 mm in thickness and subjected to the same gaseous oxygen permeability test.

The amount of gaseous oxygen permeating each evaluation film obtained in Synthetic Examples 1 to 6 was calculated as a relative value when the amount of gaseous oxygen permeating the evaluation film of Comparative Example 1 was set to 100. The results are shown in Table 1 below.

TABLE 1

| | | Aqueous | |
|---|---|---|---|
| | | methanol | |
| | | solution | Oxygen |
| | | permeability | permeability |
| | | test | test |
| No | Evaluation film | (relative value) | (relative value) |
| 1 | Polymer of Synthetic Example 1 | 0.2 | 22 |
| 2 | Polymer of Synthetic Example 2 | 0.5 | 32 |
| 3 | Polymer of Synthetic Example 3 | 0.8 | 18 |
| 4 | Polymer of Synthetic Example 4 | 0.2 | 25 |
| 5 | Polymer of Synthetic Example 5 | 1.2 | 14 |
| 6 | Polymer of Synthetic Example 6 | 1.4 | 12 |
| 7 | Butyl rubber | 100 | 100 |
| | (Comparative Example 1) | | |

As is clear from Table 1, it is found that each polymer obtained in Synthetic Examples 1 to 6 has the characteristics that it is much more reduced in aqueous methanol solution permeability and gaseous oxygen permeability than the butyl rubber of Comparative Example 1. Particularly, each polymer obtained in Synthetic Examples 1 to 6 has a low permeability for an aqueous methanol solution, because the perforated evaluation film has a self-repairing function that it is increased in volume when brought into contact with the methanol solution to clog the pores.

### Example 1

### Formation of a Seal Member on an Anode Separator

A carbon anode separator having a thickness of 4 mm was prepared, the separator having a 4 mm-wide and 2 mm-deep fuel passage cut into a serpentine form. In succession, the polymer solution obtained in Synthetic Example 1 was sealed in a pencil nozzle system coating apparatus and then applied to the depths of the surface of the separator formed with a fuel passage, from a nozzle in a range 3 mm in width. Then, the coating was naturally dried and further dried under vacuum for 2 hours to cure the polymer, thereby forming a frame form seal member on the separator.

(Formation of a Seal Member on a Cathode Separator)

A carbon cathode separator having a thickness of 4 mm was prepared, the separator having a 4 mm-wide and 2 mm-deep fuel passage cut into a serpentine form. In succession, the polymer solution obtained in Synthetic Example 1 was sealed in a pencil nozzle system coating apparatus and then applied to the depths of the surface of the separator formed with an oxidizing gas passage, from a nozzle in a range 3 mm in width. Then, the coating was naturally dried and further dried under vacuum for 2 hours to cure the polymer, thereby forming a frame form seal member on the separator.

(Production of an Anode)

100 parts of a 5% perfluoroalkylsulfonic acid polymer (trademark: Nafion, manufactured by Du Pont) solution and 2 parts of a ruthenium platinate-carrying carbon powder were stirred to prepare a slurry. The obtained slurry was applied to carbon paper (trade name: TPG-H-030, manufactured by Toray Industries, Inc) by means of a coater such that the amount of ruthenium platinate carried was 1 mg/cm², and then dried to form a first catalyst layer, thereby producing an anode.

(Production of a Cathode)

100 parts of a 5% perfluoroalkylsulfonic acid polymer (trademark: Nafion, manufactured by Du Pont) and 2 parts of a platinum-carrying carbon powder were stirred to prepare a slurry. The obtained slurry was applied to carbon paper (trade name: TPG-H-030, manufactured by Toray Industries, Inc) by means of a coater such that the amount of platinum carried was 1 mg/cm², and then dried to form a second catalyst layer, thereby producing a cathode.

(Production of a Membrane Electrode)

A polymer electrolyte membrane (trademark: Nafion 115, manufactured by Cu Pont) was interposed between the obtained anode and cathode such that it was brought into contact with the first and second catalyst layers. After this laminate was sandwiched between two PET sheets, the laminate with the two PET sheets was placed in a hot press machine (trade name: Die Set Type Heater Press MKP-150D-WH, manufactured by Mikado Technos Co., Ltd.) where the laminate was carried out hot-pressing at a load of 2 MPa and temperature of 110° C. for 2 minutes. Moreover, the laminate was carried out hot-pressing by the same press machine at a load of 4 MPa and temperature of 120° C. for 2 minutes. Then, the PET sheets were peeled off to manufacture a membrane electrode.

(Fabrication of an Evaluation Cell)

The obtained membrane electrode (electrode area: 5 cm²) was sandwiched between the anode and cathode separators produced in advance in such a manner as to face the seal member, followed by cramping to fabricate an evaluation unit cell.

### Examples 2 to 6

An evaluation cell was fabricated in the same manner as in Example 1 except that each of the polymer solutions obtained in Synthetic Examples 2 to 6 was used in place of the polymer solution obtained in Synthetic Example 1 to form a seal member on the separators of the anode and cathode.

### Comparative Example 2

An evaluation cell was fabricated in the same manner as in Example 1 except that a seal member formed from a butyl rubber sheet by punching was applied to each of the anode and cathode separators with adhesive.

(Test Using a Vibrator)

Each evaluation cell obtained in Examples 1 to 6 and Comparative Example 2 was mounted on the vibration stage of a small electrokinetic vibration tester MES561 manufactured by Mitutoyo Co., Ltd. to put the cell to a vibration test in which the cell is vibrated at a frequency of 100 Hz and an amplitude acceleration of 110 m/s² in a vertical direction for 6 hours.

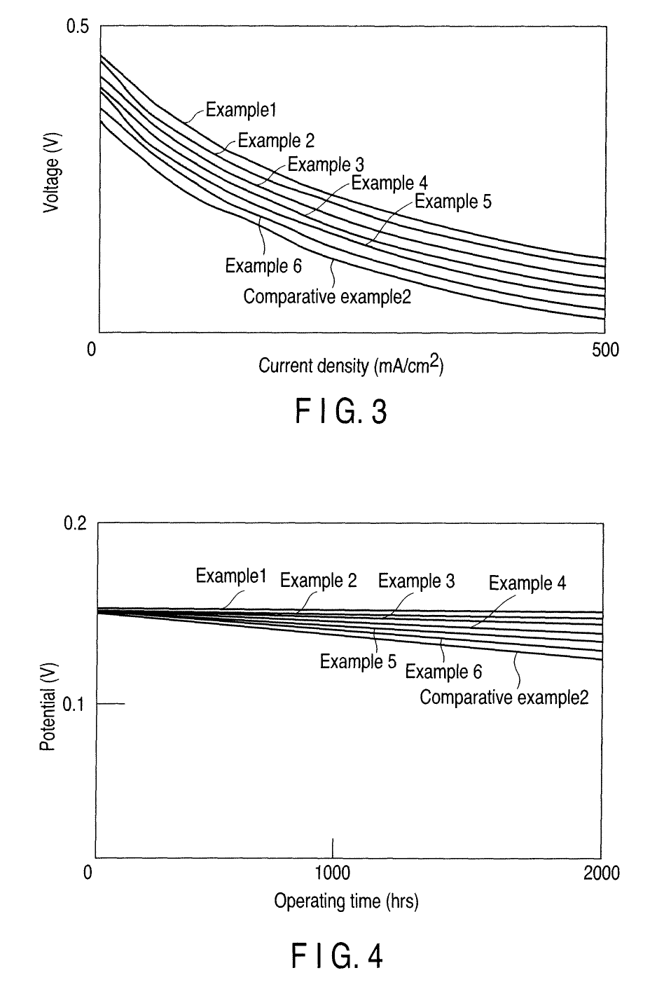

Then, each evaluation cell was connected with a fuel cell evaluation tester. An aqueous 3 wt % methanol solution (fuel) was fed to the anode side separator of the evaluation cell at a rate of 5 mL/min and air was fed to the cathode side separator of the unit cell at a rate of 10 mL/min to measure the current-voltage characteristic of each cell at 70° C. The results are shown in FIG. 3.

As is clear from FIG. 3, it is found that the cells of Examples 1 to 6 can output a higher voltage than the cell of Comparative Example 2.

Also, a variation in potential was observed when each evaluation cell was operated at 50° C. for 1000 hours by feeding an aqueous 3 wt % methanol solution (fuel) to the anode side separator of the evaluation cell at a rate of 5 mL/min and by feeding air to the cathode side separator of the unit cell at a rate of 10 mL/min while keeping a current density of 100 mA/cm². The results are shown in FIG. 4.

As is clear from FIG. 4, it is found that the cells of Examples 1 to 6 exhibit a higher potential retention rate than the cell of Comparative Example 2 even after long-term operation, showing that the cells of Examples 1 to 6 enable highly reliable power generation.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A direct-methanol fuel cell comprising:
an anode, into which an aqueous methanol solution is introduced as a fuel;
a cathode, into which oxidizing gas is introduced;
an electrolyte membrane interposed between the anode and the cathode;
an anode separator which is disposed on the anode side and formed with a fuel passage on a surface opposite the anode;
a cathode separator which is disposed on the cathode side and formed with an oxidizing gas passage on a surface opposite the cathode;
an anode frame seal member disposed in such a manner as to surround the fuel passage between the anode and the anode separator; and
a cathode frame seal member disposed in such a manner as to surround the oxidizing gas passage between the cathode and the cathode separator,
wherein the each seal member is fixed to the each separator, and
the each seal member comprises an ionic polymer represented by the following formula (I). 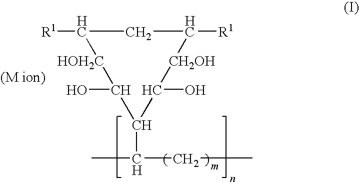
Where R¹ represents a COOH group or an H₂PO₄ group, the M ion represents Mg²⁺, Ca²⁺ or Al³⁺, m is an integer of 1 to 30 and n is an integer of 10 to 80.

2. The fuel cell of claim 1, wherein m in the formula (I) is 1 to 20.

3. The fuel cell of claim 1, wherein the anode frame seal member is formed by applying a solution containing the ionic polymer to the surface of the anode separator on the side of the fuel passage, followed by drying and the cathode frame seal member is formed by applying a solution containing the ionic polymer to the surface of the cathode separator on the side of the oxidizing gas passage, followed by drying.
